(19) United States
(12) Patent Application Publication
(10) Pub. No.: US 2017/0218888 A1
(43) Pub. Date: Aug. 3, 2017

(54) PLATE FOR COOLER INTEGRATED TO ENGINE BLOCK/HEAD

(71) Applicant: Hanon Systems, Daejeon (KR)

(72) Inventors: Carsten Ohrem, Bergheim (DE); Tae Soo Chun, Daejeon (KR); Jurgen Nothbaum, Aachen (DE)

(21) Appl. No.: 15/413,744

(22) Filed: Jan. 24, 2017

Related U.S. Application Data
(60) Provisional application No. 62/290,690, filed on Feb. 3, 2016.

(51) Int. Cl. F02M 26/31

(52) U.S. Cl. CPC F02M 26/31

(57) ABSTRACT

A primary plate for a cooling plate includes a plate having a first surface, a second surface, a recess formed therein, a plurality of first openings formed therethrough, a plurality of second openings formed therethrough, and a plurality of apertures formed through the plate adjacent a perimeter thereof and configured to receive a plurality of coupling means. Each of the plurality of first openings and the plurality of second openings is configured for receiving ends of tubes.

### CROSS-REFERENCE TO RELATED PATENT APPLICATION

This patent application claims the benefit of U.S. Provisional Patent Application Ser. No. 62/290,690, filed on Feb. 3, 2016. The entire disclosure of the above patent application is hereby incorporated herein by reference.

### FIELD OF THE INVENTION

The present invention relates to an exhaust gas recirculation (EGR) system of a combustion engine vehicle and more particularly to a plate configured to integrate the EGR system to an engine block of the combustion engine vehicle.

### BACKGROUND OF THE INVENTION

As commonly known, exhaust gas recirculation (EGR) systems of a combustion engine vehicle are employed in diesel and gasoline vehicles to reduce emissions and fuel consumption. The EGR systems recirculate a portion of gas exhausted from an engine of the combustion engine vehicle back to the engine block.

However, EGR cooling systems may include coolers that take up too much space, are unstable, have undesired sealing, are inefficient, and/or lack desired stiffness. For example, a cooler of the EGR cooling system conveying coolant is typically separate from the engine block requiring a separate housing to contain the cooler. The housing includes a cooler core or gas guiding elements such as a bundle of straight tubes, U-shaped tubes, or flat tubes, for example.

Therefore, it is desired to include an EGR cooling system wherein the cooler core is directly mounted to the engine block via a plate coupled to the cooler core. The cooler core utilizes the engine block cooling devices to cool the exhaust gases flowing through the cooler core. The cooler core and plate is typically disposed within a space formed in the engine block or cylinder head and mounted to the engine block. When mounting the cooler core to the engine block, it is desired to efficiently seal a gap formed between the plate and the engine block. One solution for sealing is to couple the plate to the engine block with screws and dispose a metal bead gasket intermediate the engine block and the plate. However, each screw and respective screw hole formed in the plate and engine block increases cost. Additionally, package requirements often prevent screws from being located at optimized areas. To minimize the cost, it is desired to minimize a number of the screws required. By minimizing the number of screws, a distance between adjacent ones of the screws increases, which negatively affects a homogeneous load applied to the metal bead gasket. Without the homogenous load, the metal bead gasket provides inadequate sealing.

Additionally, to ensure the homogeneous load is applied to the bead gasket, some applications increase a thickness of the plate to increase a stiffness of the plate. However, at least two issues result from increasing a thickness of the plate. One is, as the thickness increases, precision of forming holes for receiving the tubes during a stamping process is minimized. The tubes are brazed to the plate and precision of forming the holes for the tubes is important. The other is, as the thickness increases, a cost and a weight of the plate is increased since additional material is required.

Accordingly, it would be desirable to provide a plate assembly for coupling to the engine block of the combustion engine vehicle that is rigid, maximizes sealing, and wherein a thickness of the plate assembly is minimized.

### SUMMARY OF THE INVENTION

In accordance and attuned with the present invention, a plate assembly for coupling to the engine block of the combustion engine vehicle that is rigid, maximizes sealing, and wherein a thickness of the plate assembly is minimized has surprisingly been discovered.

According to an embodiment of the disclosure, a primary plate for a cooling plate assembly includes a plate having a first surface, a second surface, a recess formed in the plate, a plurality of first openings formed therethrough, a plurality of second openings formed therethrough, and a plurality of apertures configured to receive a plurality of coupling means formed through the plate adjacent a perimeter thereof. Each of the plurality of first openings and the plurality of second openings is configured for receiving opposing ends of a plurality of tubes.

According to another embodiment of the disclosure, a cooling plate is disclosed. The cooling plate includes a primary plate including a first surface, a second surface, a recess formed in primary plate, a first opening formed therethrough, a second opening formed therethrough, and a plurality of apertures formed therethrough. The plurality of apertures is configured to receive a plurality of coupling means. The primary plate is configured for coupling to an engine block of a combustion engine vehicle. A gasket is disposed on the second surface of the primary plate. A pair of gas boxes is disposed on the first surface of the primary plate. A first one of the pair of gas boxes provides fluid communication to the first opening and the second one of the pair of gas boxes provides fluid communication to the second opening. A plurality of tubes extend between the first opening and the second opening.

According to yet another embodiment of the disclosure, a cooling plate is disclosed. The cooling plate includes a primary plate including a first surface, a second surface, a plurality of first opening formed therethrough, a plurality of second openings formed therethrough, a plurality of apertures formed therethrough, and a recess formed in the primary plate. The plurality of apertures receiving a plurality of coupling means. The primary plate is configured for coupling to an engine block of a combustion engine vehicle. A support plate is disposed on the first surface of the primary plate. A gasket includes a bead and is disposed on the second surface of the primary plate. A pair of gas boxes is formed on the support plate. A first one of the pair of gas boxes provides fluid communication to the plurality of first openings and the second one of the pair of gas boxes provides fluid communication to the plurality of second openings. A plurality of tubes extend longitudinally with respect to the primary plate between the pair of gas boxes.

### BRIEF DESCRIPTION OF THE DRAWINGS

The above advantages of the invention will become readily apparent to those skilled in the art from reading the following detailed description of an embodiment of the invention in the light of the accompanying drawings, in which:

FIG. 1A is a bottom perspective view of a primary plate and a gasket of a cooling plate according to an embodiment of the disclosure;

FIG. 1B is a top perspective view of the primary plate and the gasket of FIG. 1A;

FIG. 1C is a cross-sectional view of the primary plate and the gasket of FIG. 1B taken along a lateral axis extending intermediate adjacent apertures formed in the primary plate and through a recess formed in the primary plate;

FIG. 2A is a top perspective view of a cooling plate according to another embodiment of the disclosure;

FIG. 2B is an enlarged fragmentary cross-sectional view taken along a lateral axis extending through a stiffening feature of the cooling plate of FIG. 2A;

FIG. 3A is a top perspective view of a cooling plate according to another embodiment of the disclosure;

FIG. 3B is a cross-sectional view of the cooling plate of FIG. 3A taken along a central longitudinal axis of the cooling plate of FIG. 3A;

FIG. 3C is an enlarged fragmentary cross-sectional view of the cooling plate of FIG. 3B taken along a central longitudinal axis of the cooling plate of FIG. 3B;

FIG. 4A is a top perspective view of a cooling plate according to another embodiment of the disclosure; and

FIG. 4B is a cross-sectional view of the cooling plate of FIG. 4A taken along a lateral axis extending intermediate adjacent apertures formed in a primary plate and through a recess formed in the primary plate.

### DETAILED DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

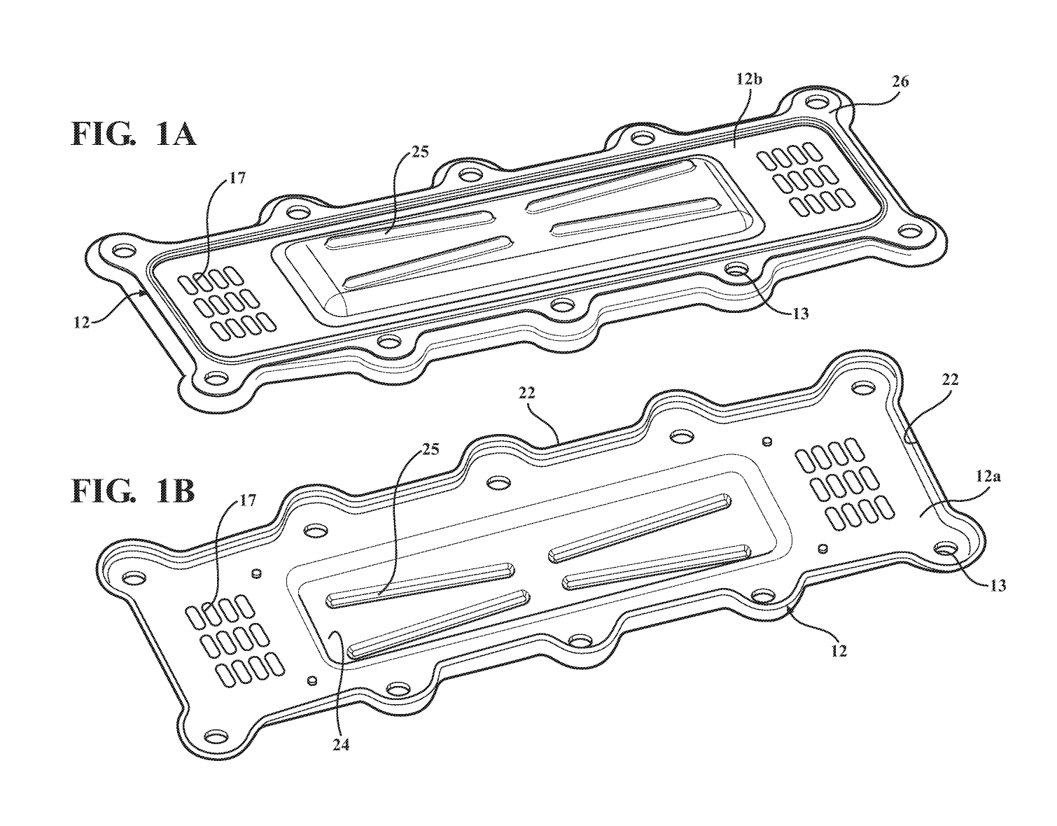

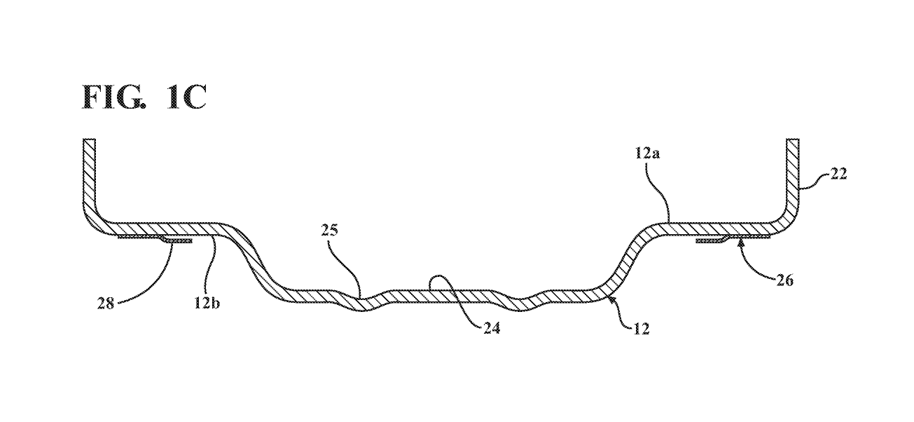

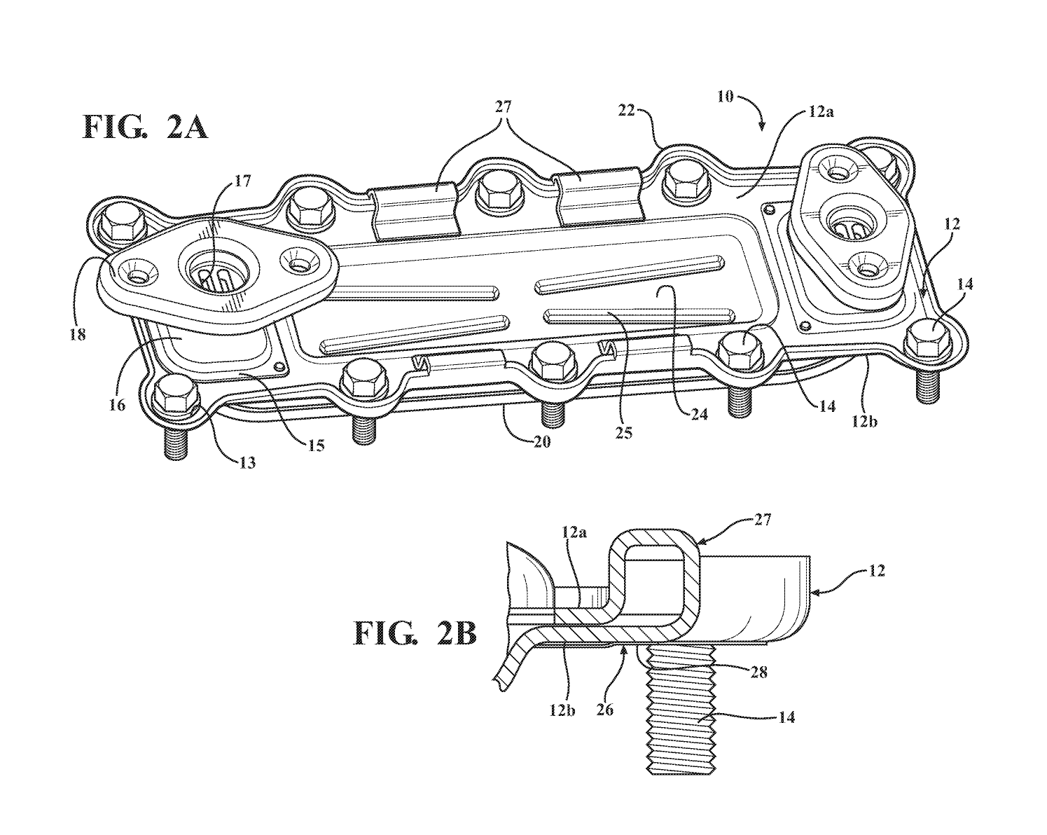

FIGS. 1A-2B illustrate a cooling plate 10 for an engine gas recirculation (EGR) system of a motor vehicle, particularly a combustion engine vehicle, according to the present disclosure. The EGR system is configured to receive a gas exhausted from an engine (not shown) of the vehicle. The EGR system may include other components commonly associated with EGR systems such as an EGR valve, for example. The cooling plate 10 includes a primary plate 12 having a first surface 12a and a second surface 12b. A plurality of apertures 13 is formed through the primary plate 12 adjacent a perimeter of the primary plate 12. The apertures 13 are configured for receiving a coupling means 14 formed proximate longitudinal edges of the primary plate 12. The coupling means 14 is configured for mounting the cooling plate 10 to an engine block (not shown) of the vehicle. As shown in the exemplary embodiment, the primary plate 12 is substantially rectangular in shape. However, the primary plate 12 can be other shapes as desired.

A pair of gas boxes 16 with outer perimeter flanges 15 is coupled to the first surface 12a of the primary plate 12 adjacent opposing ends of the primary plate 12. However, it is understood the gas boxes 16 can be integrally formed with the primary plate 12, if desired. The gas boxes 16 extend outwardly from the first surface 12a of the primary plate 12. Each of the gas boxes 16 is configured as a chamber, the chamber having an inlet and outlet providing fluid communication to a plurality of openings 17 formed in the primary plate 12. In other embodiments, the plurality of openings 17 relative to each of the gas boxes 16, respectively, can be a single opening, if desired. Each of the gas boxes 16 includes a coupling flange 18. The coupling flanges 18 provide connection of the gas boxes 16 to one of an exhaust system (not shown) of the engine block and an intake system (not shown) of the engine block.

A plurality of tubes 20 extends longitudinally with respect to the primary plate 12 between each of the openings 17 formed in the primary plate 12 to convey the gas between the gas boxes 16. The plurality of tubes 20 each extends between the openings 17 from the second surface 12b of the primary plate 12. The openings 17 enclosed by the gas boxes 16 provide fluid communication between the gas boxes 16 and the tubes 20. The tubes 20 can be any type of tube desired. For example, the tubes 20 can be U-shaped tubes, flat tubes, C-shaped tubes, or any other tubes now known or later developed.

The cooling plate 10 is configured to be disposed in an opening in the engine block or a header, wherein a coolant from a cooling system of the engine of the vehicle is received in the opening. The tubes 20 are disposed within a flow path of the coolant flowing through the opening. The coolant then circulates about an exterior of the tubes 20 to cool the gas flowing through the tubes 20 from the EGR system. The primary plate 12 facilitates closing and covering the opening to militate against leakage of the coolant from the engine block.

FIGS. 1A-1C illustrate a primary plate 12 of the cooling plate 10 according to an embodiment of the disclosure. As illustrated, the primary plate 12 includes an outer border 22 extending outwardly with respect to the first surface 12a of the primary plate 12, substantially perpendicular to a plane defined by the primary plate 12, at a perimeter of the primary plate 12. The primary plate 12 further includes the plurality of openings 17 formed therein for providing fluid communication between the gas boxes 16 and the tubes 20. The plurality of openings 17 is configured to receive an end of the tubes 20. A recess 24 is formed in a central portion of the first surface 12a of the primary plate 12. The recess 24 is also configured as a coolant guiding element to direct a flow of coolant towards the tubes 20. The recess 24 minimizes a volume of space between the second surface 12b of the plate 12 and the tubes 20, wherein the flow of the coolant is concentrated along the tubes 20. A plurality of ribs 25 is formed within the recess 24, wherein the ribs 25 recede with respect to the first surface 12a and protrude with respect to the second surface 12b. The border 22, the recess 24, and the ribs 25 provide enhanced rigidity and sealing between the primary plate 12 and the engine block.

As shown, the second surface 12b of the primary plate 12 that engages the engine block is substantially perpendicular to the border 22 and a wall forming the recess 24. In certain embodiments, a gasket 26 contacts the second surface 12b of the primary plate 12. The gasket 26 circumscribes the recess 24 and is disposed adjacent the perimeter of the primary plate 12 to provide an enhanced seal between the primary plate 12 and the engine block at the area of contact between the primary plate 12 and the engine block.

FIGS. 2A-2B illustrate an alternate embodiment of the cooling plate 10. The cooling plate 10 of FIGS. 2A-2B is similar to the cooling plate 10 of FIGS. 1A-1C. However, the cooling plate 10 of FIGS. 2A-2B includes stiffening features 27 to further enhance stiffness and sealing and further minimize a deformation of the cooling plate 10. Features similar to the cooling plate 10 of FIGS. 1A-1C are referenced by the same reference numeral, for clarity. As shown, the stiffening features 27 are integrally formed with the border 22 and extend from the border 22 of the primary plate 12 to the first surface 12a of the primary plate 12. The stiffening features 27 step from the border to the primary plate 12, wherein a first portion of the stiffening feature 27 extends from the border 22 in a direction substantially parallel with the first surface 12a, a second portion of the stiffening feature 27 extends from the first portion of the stiffening feature 27 in a direction substantially parallel with the border 22, and a third portion of the stiffening feature 27 extends from the second portion substantially parallel with the first surface 12 and engages the first surface 12a. The stiffening features 27 are configured to facilitate stiffening of the primary plate 12 by adding additional material to the primary plate 12 at critical points of the primary plate 12 aligning with a bead 28 of the gasket 26. The stiffening features 27 are disposed intermediate adjacent ones of the apertures 13 formed in the primary plate 12. The stiffening features 27 may be coupled to the first surface 12a by a weld or by a brazing process, for example. However, the stiffening features 27 can be coupled to the first surface 12a by other coupling means, if desired. In the embodiment shown, four stiffening features 27 are illustrated. However, any number of the stiffening features 27 can be included to maximize stiffening. Additionally, the stiffening features 27 can be separately formed from the second surface 12b and clamped about the border 22, if desired.

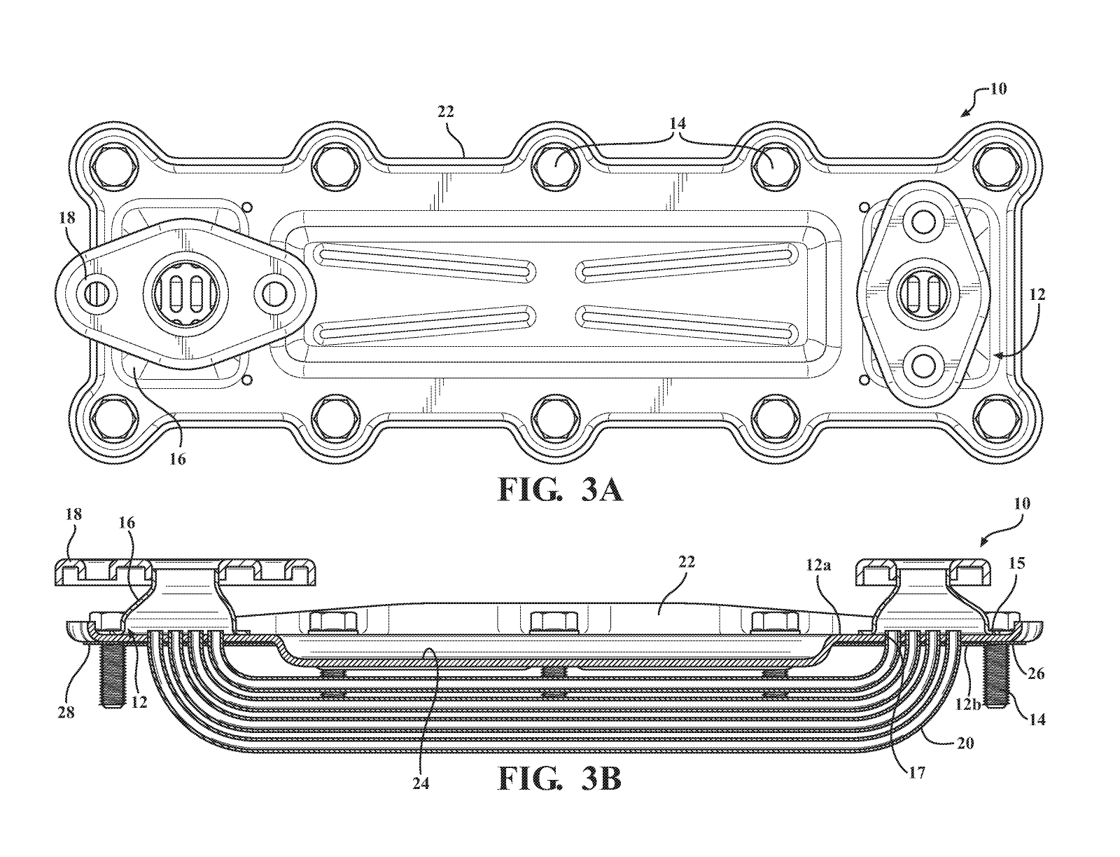

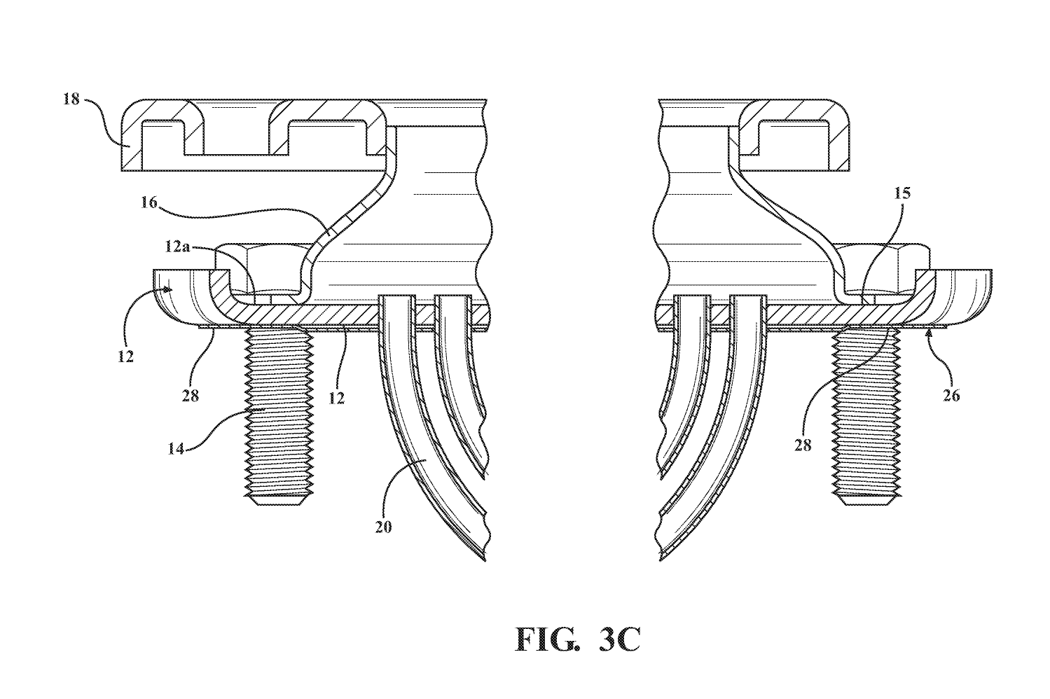

FIGS. 3A-3C illustrate an alternate embodiment of the cooling plate 10. The cooling plate 10 of FIGS. 3A-3C is similar to the cooling plate 10 of FIGS. 1A-2B. Features similar to the cooling plate 10 of FIGS. 1A-2B are referenced by the same reference numeral, for clarity. As shown, the outer perimeter flange 15 of each of the gas boxes 16 contacting the first surface 12a of the primary plate 12 is disposed in alignment with at least a portion of the bead 28 of the gasket 26. Thus, the outer perimeter flange 15 effects concentrated stiffening of the plate 12 in an area of the gasket 26 at the bead 28 to maximize sealing.

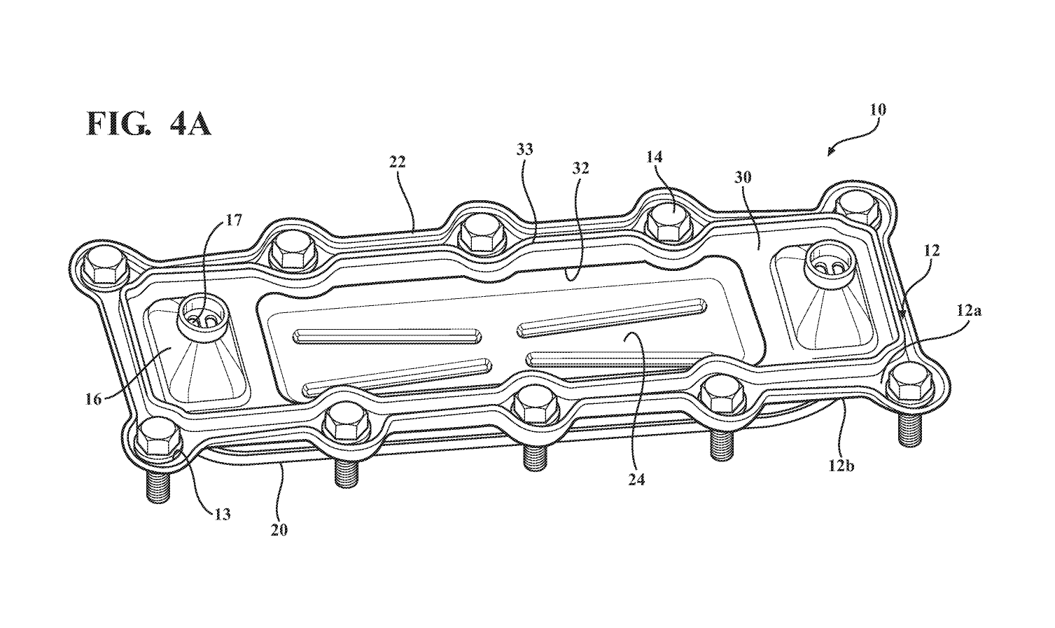

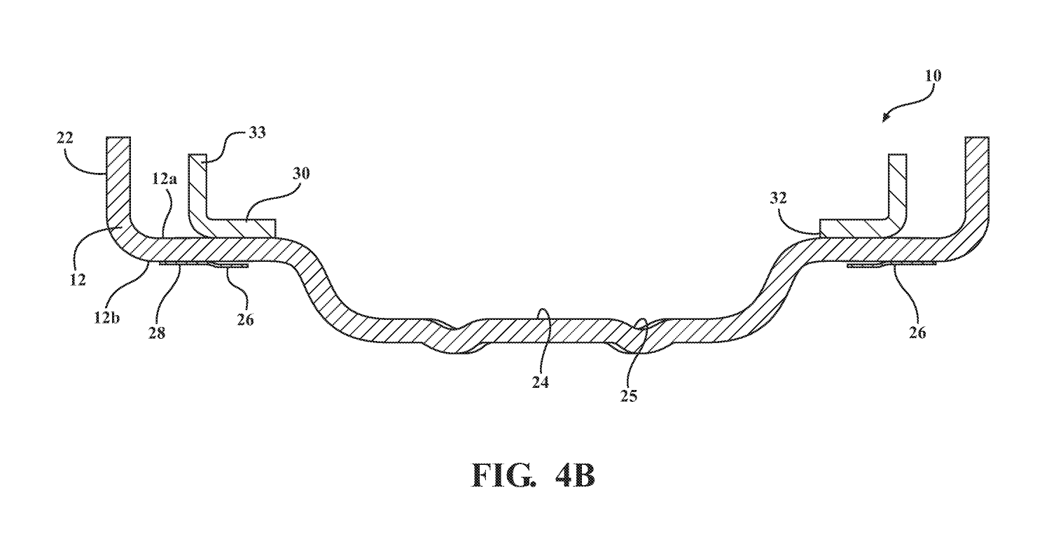

FIGS. 4A-4B illustrate an alternate embodiment of the cooling plate 10. The cooling plate 10 of FIGS. 4A-4B is similar to the cooling plate 10 of FIGS. 1A-3C except the cooling plate 10 of FIGS. 4A-4B includes a support plate 30 disposed on the primary plate 12. Features similar to the cooling plate 10 of FIGS. 1A-3C are referenced by the same reference numeral, for clarity. The support plate 30 is disposed on the first surface 12a of the primary plate 12 and within and enclosed by the border 22. The gas boxes 16 are integrally formed with the support plate 30 and extend outwardly from the support plate 30 and the primary plate 12. The support plate 30 is coupled to the primary plate 12 by any coupling means, such as a weld or brazing process, for example.

A central aperture 32 is formed within the support plate 30. In the embodiment illustrated, the central aperture 32 corresponds in shape with and aligns with the recess 24 of the primary plate 12. However, the recess 24 can have any shape as desired, depending on the application. The support plate 30 further includes a border 33 extending perpendicularly from a plane defined by a surface thereof. The border 33 of the support plate 30 is spaced from the border 22 of the primary plate 12. Although, it is understood the border 33 of the support plate 30 can be formed in contact with the border 22 of the primary plate 12 depending on the position of the bead 28 of the gasket 26. The border 33 of the support plate 30 is substantially perpendicular to a plane defined by the first surface 12a of the primary plate 12 and aligns with at least a portions the bead 28 of the gasket 26 to maximize sealing.

It is understood that the support plate 30 can include the gas boxes 16 integrally formed therewith as shown in FIGS. 4A-4B. However, in an alternate embodiment (not shown), the support plate 30 can be separate from the gas boxes 16, wherein the gas boxes 16 are coupled to the primary plate 12. In such an embodiment, the support plate 30 includes holes formed therein to receive the gas boxes 16 coupled to the primary plate 12 therethrough.

In application, the cooling plate 10 of the embodiments of FIGS. 1A-4B is coupled to the engine block or head of the combustion engine with the coupling means 14. The gas exhausted from the exhaust system of the engine block flows through a first one of the gas boxes 16 coupled to the exhaust system of the engine, through the tubes 20 extending between the gas boxes 16, and through a second one of the gas boxes 16 coupled to the intake system of the combustion engine. Coolant from the engine cooling system circulates around the tubes 20, thereby cooling the exhaust gas flowing through the tubes 20.

The primary plate 12 can be preformed by a stamping process or otherwise preformed by other processes such as molding, rolling, or other similar process. Advantageously, the cooling plate 10 according to the present disclosure provides improved sealing between the cooling plate 10 and the engine block. The primary plate 12 is robust and rigid, especially in the sealing areas where the cooling plate 10 engages with the engine block. Furthermore, the concentrated stiffness of the primary plate 12 and structural arrangement of the primary plate 12 and gasket 26 results in an increased amount of stiffness and forces being applied to the gasket 26 and specifically the bead 28 of the gasket 26 between the engine block and the primary 12 plate. As such, a homogeneous load can be applied to the gasket 26 instead of increasing the amount of the coupling means 14 required to ensure a more homogeneous load. In the absence of the additional coupling means 14, which apply the forces needed to create a desired seal, the recess 24, the border 22, the stiffening features 27, and/or the support plate 30 result in increased forces being applied at critical areas of the primary plate 12 aligning with the bead 28 of the gasket 26, such as adjacent the perimeter of the primary plate 12. As a result, the primary plate 12 can have a minimized thickness and coupling means to minimize deformation and manufacturing costs and complexity.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A primary plate for a cooling plate comprising:
a plate having a first surface, a second surface, a recess formed therein, a plurality of first openings formed therethrough, a plurality of second openings formed therethrough, and a plurality of apertures formed through the plate adjacent a perimeter thereof and configured to receive a plurality of coupling means therein, each of the plurality of first openings and the plurality of second openings is configured to receive opposing ends of a plurality of tubes.

2. The primary plate of claim 1, wherein a plurality of ribs is formed in the recess.

3. The cooling plate of claim 1, wherein the plate includes an outer border extending outwardly from the first surface of the plate perpendicular to a place defined by the plate at a perimeter of the plate.

4. The cooling plate of claim 3, wherein the plate includes stiffening features extending from the border to the first surface of the primary plate.

5. A cooling plate comprising:
a primary plate including a first surface, a second surface, a recess formed therein, a first opening formed therethrough, a second opening formed therethrough, and a plurality of apertures formed therethrough, the plurality of apertures configured to receive a plurality of coupling means, the primary plate configured to be coupled to an engine block of a combustion engine vehicle;
a gasket disposed on the second surface of the primary plate;
a pair of gas boxes disposed on the first surface of the primary plate, a first one of the pair of gas boxes providing fluid communication to the first opening and a second one of the pair of gas boxes providing fluid communication to the second opening; and
a plurality of tubes extending between the first opening and the second opening.

6. The cooling plate of claim 5, wherein the recess is formed in a central portion of the first surface of the primary plate.

7. The cooling plate of claim 5, wherein a plurality of ribs is formed in the recess.

8. The cooling plate of claim 5, wherein the first opening is divided into a plurality of first openings and the second opening is divided into a plurality of second openings.

9. The cooling plate of claim 5, wherein the pair of gas boxes is disposed adjacent opposing ends of the primary plate.

10. The cooling plate of claim 5, wherein the primary plate includes an outer border extending outwardly from the first surface of the primary plate substantially perpendicular to a plane defined by the plate at a perimeter of the primary plate.

11. The cooling plate of claim 5, wherein the primary plate includes a plurality of stiffening features extending from the border to the first surface thereof .

12. The cooling plate of claim 11, wherein each of the plurality of stiffening features is disposed intermediate adjacent ones of the plurality of apertures formed in the primary plate.

13. The cooling plate of claim 5, wherein each of the pair of gas boxes includes an outer perimeter flange engaging the first surface of the primary plate.

14. The cooling plate of claim 13, wherein the outer perimeter flange is disposed in alignment with a portion of a bead of the gasket.

15. The cooling plate of claim 5, further comprising a support plate disposed on the first surface of the primary plate, the pair of gas boxes integrally formed with the support plate.

16. The cooling plate of claim 5, further comprising a support plate having a pair of holes, the support plate disposed on the first surface of the primary plate and receiving the pair of gas boxes through the pair of holes.

17. The cooling plate of claim 5, wherein the primary plate is formed by a stamping process.

18. The cooling plate of claim 5, wherein the plurality of apertures is formed adjacent a perimeter of the primary plate.

19. A cooling plate comprising:
a primary plate including a first surface, a second surface, a plurality of first opening formed therethrough, a plurality of second openings formed therethrough, a plurality of apertures formed therethrough, and a recess formed in the primary plate, the plurality of apertures receiving a plurality of coupling means, the primary plate configured to be coupled to an engine block of a combustion engine vehicle;
a support plate disposed on the first surface of the primary plate;
a gasket including a bead disposed on the second surface of the primary plate;
a pair of gas boxes is formed on the support plate, a first one of the pair of gas boxes providing fluid communication to the plurality of first openings and the second one of the pair of gas boxes providing fluid communication to the plurality of second openings; and
a plurality of tubes extending longitudinally with respect to the primary plate between the pair of gas boxes.

20. The cooling plate of claim 19, wherein the support plate includes a border aligning with and substantially perpendicular to the bead of the gasket.
